(19) United States
(12) Patent Application Publication
(10) Pub. No.: US 2025/0346076 A1
(43) Pub. Date: Nov. 13, 2025

(54) TRACK WIDENER FOR INFLATING/DEFLATING TYRES OF A VEHICLE

(71) Applicant: TELEFLOW SAS, MABLY (FR)

(72) Inventor: Enguerrand PLANCHET, MABLY (FR)

(21) Appl. No.: 18/872,736

(22) PCT Filed: May 4, 2023
(86) PCT No.: PCT/EP2023/061878

§ 371 Date: Dec. 6, 2024

(30) Foreign Application Priority Data
Jun. 7, 2022 (FR) 2205460

(51) Int. Cl. B60C 23/00; B60B 27/00

(52) U.S. Cl. CPC B60C 23/00345; B60B 27/0047

(57) ABSTRACT

A track widener (1) has a movable part (2) capable of being attached between a first component (3) and at least one second component (4), both of which can rotate about an axis of rotation (R) of a fitted assembly of a vehicle. The movable part (2) has an axis of rotation (R) intended to be coaxial with the axis of rotation (R) of the fitted assembly. A static part (7) is capable of being connected to at least one immovable element of the vehicle. A guide system (8) guides the rotational movement between the movable part (2) and the static part (7). The track widener further has an airtightness system (9) defining a chamber (10) between the movable part (2) and the static part (7), at least one main fluid pipe (11) provided in the static part (7) and opening into the chamber (10) on one side and to the outside of the track widener (1) on the other side, and at least one secondary fluid pipe (12) provided in the movable part (2) and opening into the chamber (10) on one side and to the outside of the widener on the other side.

### TECHNICAL FIELD

The invention relates to the technical field of central tyre inflation systems (CTIS). Prior art

The prior art discloses CTIS for adjusting the pressure in the tyres of the wheels of a vehicle when said pressure has to be adapted to the driving conditions.

For example, the tyre pressure in a vehicle travelling on soft ground should be low so as to maximise grip and allow the vehicle to move forward.

Once the soft ground has been passed, the tyre pressure should be increased so that the vehicle can travel at a higher speed, for example when the vehicle joins a road.

CTIS typically include swivel joints for connecting each vehicle tyre to a compressed-air source and to an outflow. It is therefore possible to both increase and decrease the tyre pressure without having to handle individual pneumatic elements. In particular, the pressure can be adjusted while the vehicle is in motion.

On-board CTIS are becoming widespread, in particular for 4×4 or off-road vehicles. Some of these vehicles are equipped with CTIS from the design phase or are pre-designed with, for example, a sealed supply pipe to the vehicle wheel. When the vehicle is pre-equipped to receive a CTIS, it is usually already equipped with swivel joints. A supply valve should then be attached using the swivel joint between the end of said sealed pipe, which is generally fixed in place on the vehicle, and the wheel, which is rotationally driven about its axis.

CTIS adaptation systems have been developed for vehicles that lack any such complete or partial installation. These are usually a supply valve attached to the centre of the wheel and connected to a sealed pipe fixed in place on the vehicle. However, the size of the wheel arch generally means that this supply valve has to be positioned on the outside of the vehicle, which, in addition to being unsightly, has a detrimental effect on the durability of the supply valve or supply pipe, potentially rendering the CTIS inoperative.

Similarly, this supply valve is equipped with a swivel joint so that the valve rotates together with the wheel while the fluid supply pipe is fixed in place. This prototype solution still has to be adapted to each vehicle, which is laborious and expensive.

Documents WO2011015368A1, EP2647511A2 and WO2014022265A1 describe CTIS that are not entirely satisfactory. The design described in these documents does not guarantee either a good service life or good performance of the swivel joint.

### SUMMARY OF THE INVENTION

An object of the invention is to overcome the drawbacks of the prior art by proposing an additional apparatus on the vehicle for installing and operating a tyre inflation/deflation system, said apparatus being compatible with any type of vehicle and remedying the problems of reliability and aesthetics resulting from direct adaptation on the wheel.

For this purpose, a track widener has been developed, comprising:
a movable part capable of being attached between a first component and at least one second component, both of which can rotate about an axis of rotation of a fitted assembly of a vehicle, the movable part having an axis of rotation intended to be coaxial with the axis of rotation of the fitted assembly,
a static part capable of being connected to at least one immovable element of the vehicle,
a system for guiding the rotational movement between the movable part and the static part.

According to the invention, the track widener comprises:
an airtightness system defining a chamber between the movable part and the static part,
at least one main fluid pipe provided in the static part and opening into the chamber on one side and to the outside of the track widener on the other side,
at least one secondary fluid pipe provided in the movable part and opening into the chamber on one side and to the outside of the track widener on the other side.

On the basis of the above, the additional apparatus for installing and operating a tyre inflation system is in the form of a track widener.

The widener is thus positioned internally at the vehicle wheel so that it is protected against damage from the outside and is not visible, meaning that it does not affect the overall aesthetics of the vehicle.

Furthermore, fitting the track widener between two rotating components of the vehicle ensures better dynamic balancing compared with existing solutions fitted at the axial end of the rotating components. This feature also makes it possible to better control the coaxiality of the various rotating parts.

The track widener according to the invention is fitted between existing components of the vehicle and does not require any major modification to those components, so it is simple to implement.

The end of the at least one main fluid pipe that opens to the outside of the widener makes it possible to connect a supply valve which is connected to a compressed-air supply circuit of the vehicle, so the invention can be adapted to all types of vehicles.

Since the end of the at least one secondary fluid pipe that opens to the outside of the widener rotates together with the wheel, this end can be connected to the fluid cavity formed by the rim and the tyre.

Thus, the components, the wheel and the tyre are all driven by the same rotational movement, and so end pieces, one positioned at said end of the secondary fluid pipe opening towards the outside of the widener and the other positioned at the inlet of the fluid cavity, are not equipped with rotary systems. This leads to lower costs and improved durability.

Preferably, the guide system is positioned radially to the axis of rotation of the movable part internally or externally in relation to the sealing system, which makes it possible to improve the quality of the rotation of the movable part relative to the static part by enhancing the coaxiality. This also helps to reduce the mechanical stresses on the sealing system and the risk of air leakage.

Furthermore, in the configuration in which the guide system is radially further from the axis of rotation than the sealing system, a compact geometry of the track widener can be ensured.

The guide system implemented is of any suitable type, for example in the form of a ball bearing having one or more rows of balls, a needle bearing, a roller bearing, a self-lubricating bearing, a bearing bush or any other suitable guide system.

The sealing system is of any suitable type and is, for example, in the form of lip seals, V-ring seals, O-rings, quad seals, cassette seals or any other suitable sealing system.

According to a particular embodiment, the minimum cross section of the main fluid pipe, when there is only one such pipe, or the sum of the minimum cross sections of the main fluid pipes, when there is more than one such pipe, is between 10 and 200 mm², preferably between 20 and 150 mm² and highly preferably between 25 and 90 mm².

Each main fluid pipe has a minimum cross section, which is the smallest fluid-passage cross section perpendicular to the fluid path defined by the main fluid pipe. Regardless of whether there is one or more than one main fluid pipe, all the minimum cross sections of the network of main fluid pipes should be between the aforementioned end values. This defines the ease with which the compressed air flows in the network of fluid pipes to the annular chamber and determines the level of mechanical stresses on the static part. Multiplying the fluid pipes ensures the inflation/deflation functionality even in the unfortunate event that one fluid pipe is obstructed.

Preferably, the static part of the track widener comprises a single main fluid pipe, which makes it possible to have only a single connection, without a swivel joint, between the track widener and a compressed-air reserve already present in the vehicle.

Preferably, the minimum cross section of the secondary fluid pipe, when there is only one such pipe, or the sum of the minimum cross sections of the secondary fluid pipes, when there is more than one such pipe, is the same as the minimum cross section of the single main fluid pipe or the sum of the minimum cross sections of the main fluid pipes. Thus, having a constant cross section between the static part and the movable part, which are connected in series, allows the fluid to flow more easily.

Advantageously, the movable part comprises at least two secondary fluid pipes which are regularly angularly distributed about the axis of rotation, in order to ensure better mass distribution and better balancing of the movable part since the movable part is rotationally driven. This also makes it possible to improve the durability of the components that can move about the axis of rotation of the fitted assembly.

A minimum cross section of each secondary fluid pipe is greater than 5 mm².

According to a particular embodiment, the secondary fluid pipe opens to the outside of the widener at the rotational axis of the movable part, which makes it possible to ensure better dynamic balancing on the movable part since the movable part is rotationally driven. This also makes it possible to improve the durability of the components that can move about the axis of rotation of the fitted assembly.

Advantageously, a smaller axial dimension of the movable part of the widener, i.e. along the axis of rotation, between a first bearing face of the first component and a second bearing face of the at least one second component is less than 120 mm, preferably less than 60 mm and highly preferably less than 30 mm.

This feature makes it possible to quantify the maximum axial offset of the fitted assembly with respect to its initial position before the track widener is installed. The smaller the offset, the better the mechanical durability of the vehicle and of the rotary guide elements, for example the ball bearings. This thus minimises the structural modifications that have to be made to the vehicle in order to install the widener according to the invention.

The invention also relates to a vehicle comprising a track widener according to any of the aforementioned features fitted between a first component and a second component, both of which can rotate about an axis of rotation of a fitted assembly of the vehicle selected from a group comprising: a brake disc, an axle, a hub, a spindle, bearings, a second originally present track widener, etc. This selection helps to simplify the system for attachment to the vehicle by using the pre-existing components of the vehicle, thereby reducing space requirements and limiting costs.

The invention also relates to a method for attaching a track widener according to any of the aforementioned features between a first component and at least one second component, both of which can rotate about an axis of rotation of a fitted assembly of a vehicle.

According to the invention, the movable part is attached to the second component by using an attachment system that is originally present on the vehicle and was previously intended for attaching the fitted assembly, the fitted assembly being rigidly attached to the rotatable part of the widener by a similar attachment system.

### BRIEF DESCRIPTION OF THE DRAWINGS

FIG. 1 is a longitudinal sectional view of the track widener according to the invention fitted between a rim and a hub of a fitted assembly of a vehicle, the section passing through the main and secondary fluid channels.

FIG. 2 is a longitudinal sectional view of the track widener similar to that in FIG. 1, the section passing through the means for attaching the movable part to the first and second movable components of the vehicle.

### DETAILED DESCRIPTION OF THE INVENTION

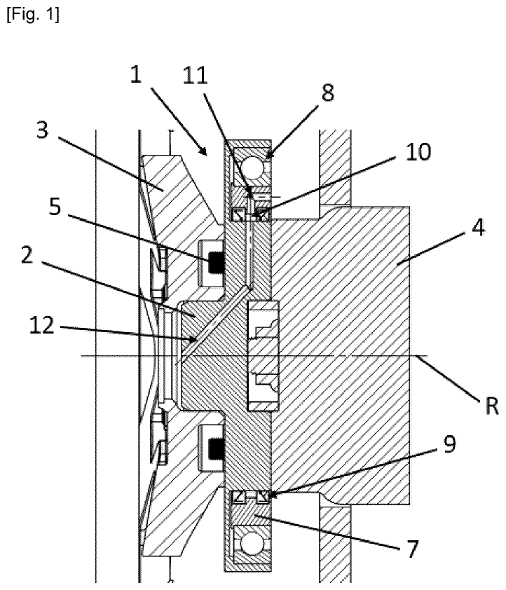

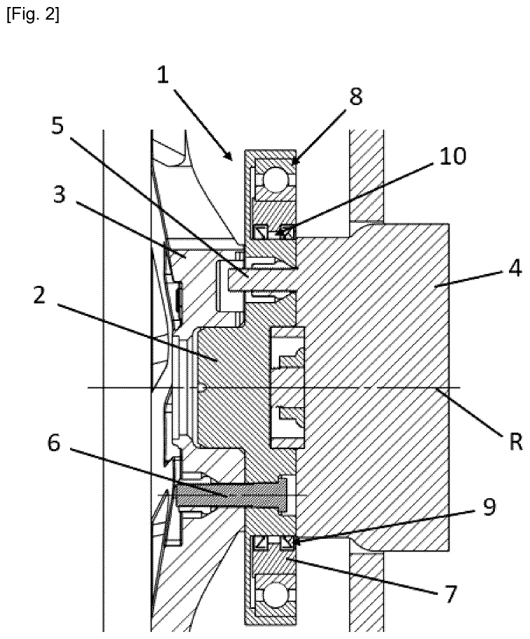

With reference to FIGS. 1 and 2, the invention relates to a track widener (1) that is intended for being fitted on a vehicle and allows a central tyre inflation system (CTIS) to be installed and operated.

The track widener (1) comprises a movable part (2), in particular in the form of a disc having a cylindrical central bearing surface, intended to be attached between a first component (3) and a second component (4) of the vehicle, both of which can rotate about an axis of rotation (R) of a fitted assembly of the vehicle. The movable part (2) is attached between the two components (3, 4) and has an axis of rotation (R) coaxial with that of the components (3, 4).

In the embodiment shown in the drawings, the movable part (2) of the track widener (1) is attached between a rim, as the first component (3), and a hub, as the second component (4), which bears a brake disc and was originally intended for receiving the rim.

For this purpose, the cylindrical bearing surface of the movable part (2) is inserted into a central bore in the rim and centred therein; it comprises first openings that are regularly distributed about the axis of rotation (R) and into which first bolts (5), which project from the hub and were originally used to fasten the rim, are to be inserted. Nuts are screwed around the bolts (5) and integrated into the body of the movable part (2) in order to fasten said movable part (2) to the hub.

On the other side, the movable part (2) is attached to the rim by means of second bolts (6) which are applied to and pass through second orifices regularly distributed about the axis of rotation (R) of the movable part (2) and project from the side of the rim so as to pass through complementary openings originally present in the rim, with everything being tightened by means of nuts.

The movable part (2) is thus attached to the second component (4) using an attachment system that is originally present on the vehicle and was previously intended for attaching the fitted assembly, the fitted assembly being rigidly attached to the rotatable part (2) of the widener by a similar attachment system, in particular nuts and bolts. The fitting is simple and reliable and does not require any major structural modification to the components (3, 4) of the vehicle.

The track widener (1) also comprises a static part (7), for example in the form of a ring, inserted into an annular groove made in the part (2) that can move about the axis of rotation (R), from a face opposite the hub. As is known in a track widener (1), the static part (7) is capable of being connected to at least one immovable element of the vehicle in order to remain static.

To ensure the rotational movement of the movable part (2) relative to the static part (7) is guided effectively, a guide system (8) is fitted radially about the axis of rotation (R) between the static part (7) and the movable part (2), in particular bearing against an external face of the static part (7) in relation to the axis of rotation (R). Protruding assemblies, which are less efficient, are avoided.

An airtightness system (9) is positioned radially about the axis of rotation (R) between the static part (7) and the movable part (2), bearing against at least one internal face of the static part (7) in relation to the axis of rotation (R), and defines a chamber (10), in particular an annular chamber about the axis of rotation (R), between the movable part (2), the static part (7) and said sealing system (9).

The radial position of the guide system (8) with respect to the airtightness system (9) ensures good guidance of the CTIS at the sealing system (9), thereby protecting it from wear and guaranteeing its performance.

The guide system (8) is therefore positioned radially in relation to the axis of rotation (R) of the movable part (2), outside the airtightness system (9). This particular arrangement allows for more space for the guidance system (8). It is therefore possible to install a more robust guide system (8) to guarantee the service life of the CTIS. For example, higher-grade ball bearings could be installed, compared with bearings that would have been arranged internally with respect to the airtightness system (9).

In addition, arranging the airtightness system (9) internally makes it possible to limit the wear thereon; since the radius of the airtightness system (9), measured from the axis of rotation (R), is reduced, the circumferential speed at the point of contact of the sealing system (9) is lower (note the relationship v=ω×r, where:
v is the circumferential speed;
ω is the rotational speed;
r is the radius of the rotation).

Since the circumferential speed at the point of contact between the sealing system (9) and its counterpart is lower, the sealing system (9) is subject to less wear.

In the example shown, the guide system (8) is in the form of a ball bearing, and the sealing system (9) comprises two annular seals positioned side by side and spaced apart from each other to define the chamber (10) between the seals, the movable part (2) and the static part (7).

The seals used may be of any suitable type, for example a radial friction lip seal positioned on the bottom side of the groove in the movable part (2), and a radial friction lip seal having a dust-proof lip positioned on the side that is open towards the outside of the groove.

Lip seals are preferred as they provide excellent sealing under dynamic conditions.

When the opposing surface of the seal lip is cylindrical (shaft seal or bore seal) rather than flat (counterbore), the good sealing obtained is guaranteed by the precision of the machining carried out in order to obtain the desired dynamic balancing on a vehicle wheel (coaxial and cylindrical nature of the machined bearing surfaces). There is therefore a synergy between the two results obtained.

According to the invention, the track widener (1) also comprises at least one main fluid pipe (11) provided in the static part (7) and opening:
to the outside of the track widener (1), for example on the hub side, at a first end and;
into the chamber (10) between the movable part (2) and the static part (7) at a second end.

The track widener (1) also comprises at least one secondary fluid pipe (12) having a minimum cross section greater than 5 mm², provided in the movable part (2) and opening:
into the chamber (10) at a first end and;
to the outside of the track widener (1) at a second end.

In this way, the first end of the main fluid pipe (11) makes it possible to position a supply valve (not shown) connected to a compressed-air supply circuit of the vehicle, and the second end of the secondary fluid pipe (12), which rotates together with the wheel, can be connected to a fluid cavity defined between the rim and the tyre. Preferably, the static part (7) comprises only one main fluid pipe (11), which makes it possible to have just one connection between the track widener (1) and the compressed-air supply circuit of the vehicle.

The air injected by the compressed-air supply circuit of the vehicle from the first end of the main fluid pipe (11) of the static part (7) thus enters the chamber (10) and flows in the secondary fluid pipe (12) of the movable part (2) to inflate the tyre or control the deflation thereof.

The track widener (1) according to the invention thus allows a tyre inflation system that is compatible with any type of vehicle to be installed and operated in a reliable manner.

The track widener (1) is positioned on the inside of the wheel and is therefore protected from external damage; it does not affect the overall aesthetics of the vehicle either.

Moreover, the dynamic balancing is optimal since the track widener (1) is positioned between two rotating components (3, 4) of the vehicle while sharing the same axis of rotation (R).

Preferably, the movable part (2) comprises at least two secondary fluid pipes (12), regularly angularly distributed about the axis of rotation (R) in order to improve the mass distribution and optimise the balancing of the rotary part (2). For this purpose too, the secondary fluid pipe(s) (12) of the movable part (2) open(s) to the outside of the widener at the axis of rotation (R) of the movable part (2), in particular into the cylindrical bearing surface.

Owing to the invention, a CTIS can be installed and operated without requiring any major modification to the constituent parts of the vehicle.

Even if in practice the radial dimension of the track widener (1) is to be minimised in order to limit friction and wear, the movable part (2) could have a sufficient radial dimension so as to protrude radially from the hub so that the airtightness system (9) positioned between the movable part (2) and the static part (7) can be accessible without removing the assembly.

Preferably, the minimum cross section of the main fluid pipe, when there is only one such pipe, or the sum of the minimum cross sections of the main fluid pipes (11), when there is more than one such pipe, is between 10 and 200 mm², preferably between 20 and 150 mm² and highly preferably between 25 and 90 mm². Furthermore, the minimum cross section of the secondary fluid pipe, when there is only one such pipe, or the sum of the minimum cross sections of the secondary fluid pipes (12), when there is more than one such pipe, is the same as the minimum cross section of the single main fluid pipe (11) or the sum of the minimum cross sections of the main fluid pipes (11).

To improve the mechanical durability of the vehicle and minimise the structural modifications that have to be carried out on the vehicle, the smallest axial dimension of the movable part (2), between a bearing face of the first component (3) and a bearing face of the second component (4), is less than 120 mm, preferably less than 60 mm and highly preferably less than 30 mm. The smaller this dimension, the better the mechanical durability of the vehicle.

On the basis of the above, the invention provides an additional apparatus on the vehicle, namely a track widener for installing and operating a tyre inflation/deflation system, said apparatus being compatible with any type of vehicle and solving the problems of reliability and aesthetics resulting from direct adaptation on the wheel.

1. A track widener comprising:
a movable part capable of being attached between a first component and at least one second component, both of which can rotate about an axis of rotation of a fitted assembly of a vehicle, the movable part having an axis of rotation intended to be coaxial with the axis of rotation of the fitted assembly,
a static part capable of being connected to at least one immovable element of the vehicle,
a guide system for guiding the rotational movement between the movable part and the static part,
an airtightness system defining a chamber between the movable part and the static part,
at least one main fluid pipe provided in the static part and opening into the chamber on one side and to the outside of the track widener on the other side, and
at least one secondary fluid pipe provided in the movable part and opening into the chamber on one side and to the outside of the track widener on the other side,
wherein the guide system is positioned radially to the axis of rotation of the movable part in relation to the sealing system.

2. (canceled)

3. The track widener (1) according to claim 1, wherein the guide system is in a group comprising: a ball bearing having one or more rows of balls, a needle bearing, a roller bearing, a self-lubricating bearing, a bearing bush.

4. The track widener according to any of claim 1, wherein the sealing system is in a group comprising: lip seals, V-ring seals, O-rings, quad seals, cassette seals.

5. The track widener according to claim 1, wherein the minimum cross section of the main fluid pipe, when there is only one such pipe, or the sum of the minimum cross sections of the main fluid pipes is between 10 and 200 mm².

6. The track widener according to claim 5, wherein the static part of the widener comprises a single main fluid pipe.

7. The track widener according to claim 1, wherein the minimum cross section of the secondary fluid pipe, when there is only one such pipe, or the sum of the minimum cross sections of the secondary fluid pipes is the same as the minimum cross section of a single main fluid pipe or the sum of the minimum cross sections of the main fluid pipes.

8. The track widener (1) according to claim 7, wherein the movable part comprises at least two secondary fluid pipes, regularly angularly distributed about the axis of rotation.

9. The track widener according to claim 1, wherein a minimum cross section of each secondary fluid pipe is greater than 5 mm².

10. The track widener according to claim 1, wherein the secondary fluid pipe opens to the outside of the widener at the axis of rotation of the movable part.

11. The track widener according to claim , wherein a smaller axial dimension of the movable part between a first bearing face of the first component (3) and a second bearing face of the at least one second component (4) is less than 120 mm.

12. A vehicle comprising a track widener according to claim 1, fitted between a first component and a second component, both of which can rotate about an axis of rotation of a fitted assembly of the vehicle selected from a group comprising: a wheel, a brake disc, an axle, a hub, a spindle, bearings, a second track widener.

13. A method for attaching a track widener according to claim 1, between a first component and at least one second component, both of which can rotate about an axis of rotation of a fitted assembly of a vehicle, wherein the movable part is attached to the second component using an attachment system that is originally present on the vehicle and was previously intended for attaching the fitted assembly, the fitted assembly being rigidly attached to the rotatable part of the widener by a similar attachment system.
